(19) United States
(12) Patent Application Publication
(10) Pub. No.: US 2019/0009185 A1
(43) Pub. Date: Jan. 10, 2019

(54) HEXAVALENT CHROMIUM FREE ETCH MANGANESE VACUUM EVAPORATION SYSTEM

(71) Applicant: SRG Global, Inc., Troy, MI (US)

(72) Inventors: Mark Bauman, Troy, MI (US); Daniel Lacey, Troy, MI (US); Gerry Vogelpohl, Troy, MI (US)

(73) Assignee: SRG Global, Inc., Troy, MI (US)

(21) Appl. No.: 16/030,835

(22) Filed: Jul. 9, 2018

Related U.S. Application Data
(60) Provisional application No. 62/530,564, filed on Jul. 10, 2017.

(51) Int. Cl. B01D 3/10; C09K 13/00; B01D 1/22; B01D 3/14

(52) U.S. Cl. CPC B01D 3/10; B01D 3/148; B01D 1/222; C09K 13/00

(57) ABSTRACT

Methods and systems for removing water from a manganese-based etchant bath are disclosed. Water is removed from the manganese-based etchant bath by transferring a portion of the manganese-based etchant bath to a vacuum evaporator for processing and transferring the concentrated portion of the manganese-based etchant bath back to the manganese-based etchant bath.

### CROSS REFERENCE TO RELATED CASES

The present application claims priority from U.S. Provisional Application No. 62/530,564 filed on Jul. 10, 2017, which is hereby incorporated by reference in its entirety.

### FIELD

The present disclosure relates to hexavalent chromium free etch manganese vacuum evaporation systems.

### BACKGROUND

This section provides background information related to the present disclosure which is not necessarily prior art.

Many conventional processes to metallize a nonconductive substrate include etching the substrate, followed by activation, followed by electroless metallization. In many such conventional processes, etching the substrate was accomplished by dipping the substrate in a chromic acid-sulfuric acid mixture.

Many such etching processes predominantly utilized hexavalent chromium. In the past several years, however, the use of hexavalent chromium etchants has declined because of the healthcare risks hexavalent chromium poses. Other methods have avoided using chromium in the etchant solution altogether. One such etchant solution developed for metallizing nonconductive substrates comprises a source of Mn ions at oxidation states including (+2, +3 +4 +5 +6 and +7). Such etchant solutions, however, may absorb an unwanted amount of water from ambient air, thereby requiring the etchant solution to be continually monitored and balanced to ensure it is working optimally. There is a need to optimize such a solution.

### SUMMARY

This section provides a general summary of the disclosure, and is not a comprehensive disclosure of its full scope or all of its features.

The present technology provides a method for removing water from a source of manganese ions. The method includes directing at least a portion of a source of manganese ions through a conduit, wherein the conduit comprises a filter for filtering undissolved particles. The portion of the source of manganese ions directed through the conduit is concentrated in a vacuum evaporator. The concentrated portion is returned to a manganese-based etchant bath. In other embodiments, concentrated portion comprises an acid. In yet other embodiments, the acid is purified. In further embodiments, the vacuum evaporator comprises a heat source. In even further embodiments, the manganese-based etchant bath is configured to etch a substrate. Other embodiments include a second conduit that returns the concentrated portion to the manganese-based etchant bath. In other further embodiments, the conduit comprises a one-way valve for preventing the portion of the source of manganese ions from returning to the source of manganese ions via the conduit.

The present technology provides additional methods for removing water from a manganese-based etchant bath. The method includes directing at least a portion of a manganese-based etchant bath through a conduit. The conduit comprises a one-way valve for prohibiting the portion of the manganese-based etchant bath from returning to the manganese-based etchant bath via the conduit. The vacuum evaporator concentrates the portion of the manganese-based etchant bath directed through the conduit. The concentrated portion is returned to the manganese-based etchant bath. In yet other embodiments, the conduit further comprises a filter for filtering undissolved particles. In further embodiments, the concentrated portion comprises an acid. In even further embodiments, the acid is purified. In yet further embodiments, the vacuum evaporator further comprises a heat source. In additional embodiments, the manganese-based etchant bath is configured to etch a substrate. In other additional embodiments, a second conduit returns the concentrated portion to the manganese-based etchant bath.

The present disclosure also provides a system for removing water from a manganese-based etchant bath. The system comprises a manganese-based etchant bath, a first conduit, a vacuum evaporator, and a second conduit. The first conduit is connected at a first end to the manganese-based etchant bath and at a second end to the vacuum evaporator and further comprises a filter for filtering undissolved particulates. The first conduit further allows at least a portion of the manganese-based etchant bath to flow through the first conduit into the vacuum evaporator. The vacuum evaporator evaporates water from and concentrates the portion of the manganese-based etchant bath that flows through the first conduit. The second conduit is configured for one-way passage from the vacuum evaporator to the manganese-based etchant bath. In other embodiments, the vacuum evaporator comprises a heating source for heating the contents of the vacuum evaporator. In yet other embodiments, the manganese-based etchant bath is configured to etch a substrate. In further embodiments, the concentrated portion comprises an acid. In yet further embodiments, the first conduit is configured for one-way passage from the manganese-based etchant bath to the vacuum evaporator.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a flowchart of a process for preparing an electrolessly metallized substrate;

FIG. 2 is a schematic of a vacuum evaporation system according to an aspect of this invention

FIG. 3 shows a representative flow diagram for the evaporator system within the etching process

FIG. 4 shows the processing parameters for an example according to the vacuum evaporation system of FIG. 2 and FIG. 3; and

FIG. 5 is a graph depicting the results of a range of processing conditions for the example of FIG. 4.

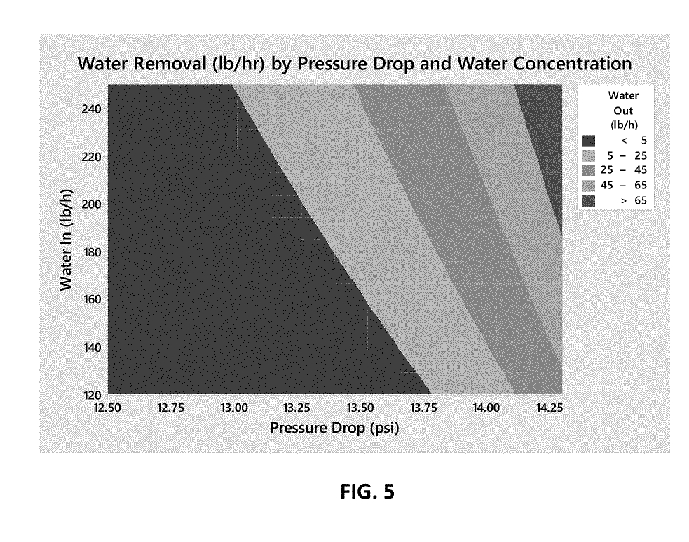

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In various aspects, the present disclosure provides a dewatering system for improving the etching process used in a manufacturing process for etching nonconductive substrates. Generally, etching nonconductive substrates are useful for electrolessly metallizing the substrates, and such substrates are particularly suitable for use in components of an automobile or other vehicle, and may additionally be used in a variety of other industries and applications, including aerospace components, farm equipment, industrial equipment and heavy machinery, by way of non-limiting example. Further, the present disclosure is useful in streamlining methods for forming lightweight, corrosion resistant components for a vehicle, including vehicle fascia, and interior and exterior decorative trim, by way of non-limiting example.

Appropriate nonconductive substrates for use according to the disclosure herein include many different plastics and include many plastic resins including phenolic, urea formaldehyde, polyethersulfone, polyacetal, diallyl phthalate, polyetherimide, Teflon, polyarylether, polycarbonate, polyphenylene oxide, mineral-reinforced nylone, and polysulfone. A particularly suitable plastic for use according to the disclosure herein is acrylonitrile-butadiene-styrene (ABS). Further, there are blends that are susceptible to etching and electroless metallization, such as polycarbonate ABS blends.

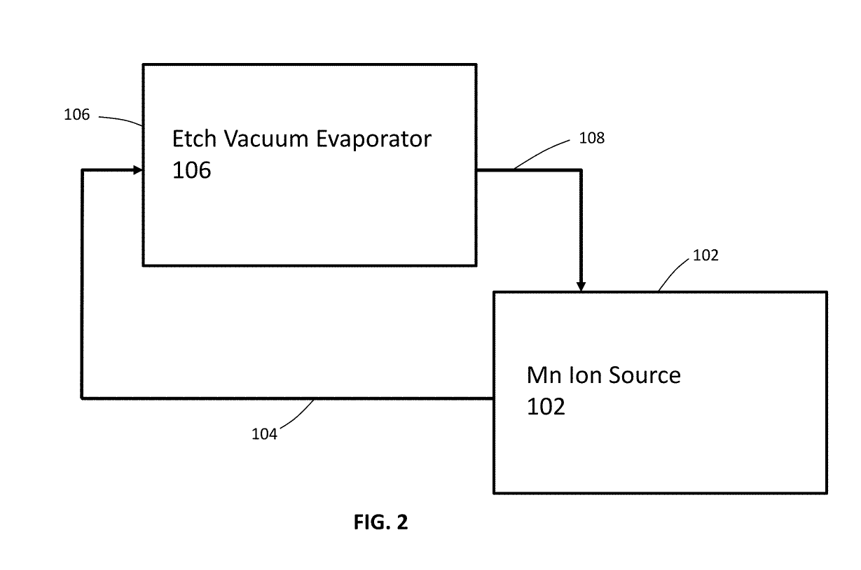

Referring first to FIG. 2, an exemplary evaporating system is shown according to the disclosure herein. A portion of a source of manganese ions 102 is removed from a first conduit 104. First conduit 104 directs the portion of the bath to vacuum evaporator 106. The portion of the bath directed to vacuum evaporator 106 is evaporated in vacuum evaporator 106. Evaporating in vacuum evaporator results in distillate water and concentrated liquid. The concentrated liquid is directed through second conduit 108 and fed back into manganese-based etchant bath 102. The distillate water may be further collected, processed, and reused or discarded.

The source of manganese ions may be any of a manganese-based etchant bath.

First conduit 104 may comprise any medium for transferring a liquid from one area to another and may include, as non-limiting examples, piping, tubing, channel, ductwork, or any other transferring assembly capable of transferring a liquid from one area to another. First conduit 104 may be formed of any material exhibiting suitable acid resistance. First conduit 104 may further comprise a filter for prohibiting particulates from entering vacuum evaporator 106. First conduit 104 may further comprise a pump for increasing the flow to the vacuum evaporator 106. First conduit 104 may further comprise a one-way valve for prohibiting the at least a portion of the manganese-based etchant bath from returning to manganese-based etchant bath 102 via first conduit 104.

Manganese-based etchant baths use strong acids; therefore, suitable vacuum evaporators for use according to the present invention are those that are capable of resisting acid corrosion and capable of concentrating strong acids, including the following acids used in manganese-based etchant baths: phosphoric acid, peroxomonophosphoric acid, peroxodisphosphoric acid, sulfuric acid, peroxomonosulfuric acid, and peroxodisulfuric acid, and methane sulfonic acid. While the starting concentrations are dependent on the rates at which substrates are rinsed and/or dragged out and/or the manganese-based etchant bath itself, suitable vacuum evaporators are comprised of materials that resist corrosive acid attack at high acid concentrations (e.g., acid concentrations approaching the limit of how well vacuum evaporators presently can evaporate water). Non-limiting examples of appropriate vacuum evaporators include single effect evaporators, including single effect climbing film evaporators; multiple effect evaporators, including triple effect evaporators; and rising thin film vacuum evaporators. The vacuum evaporators according to the present disclosure further include vacuum distillation units, including rotary evaporators and dry vacuum distillation columns. Preferably, the vacuum evaporator employs a heat source to further speed up the rate of evaporation. Suitable heat sources include heat exchangers including steam and oil heat exchangers. After evaporation, the concentrated acid may subsequently be purified.

Second conduit 108, like first conduit 104, may comprise any medium for transferring a liquid from one area to another and may include, as non-limiting examples, piping, tubing, channel, ductwork, or any other transferring assembly capable of transferring a liquid from one area to another. Second conduit 108 may be formed of any material exhibiting suitable acid resistance. Notably, materials suitable for forming first conduit 104 may not be suitable for forming second conduit 108 as second conduit 108 must exhibit sufficient acid resistance to withstand the concentrated liquid resulting from vacuum evaporation. Second conduit may further comprise a one-way valve for prohibiting the concentrated liquid from returning to vacuum evaporator 106.

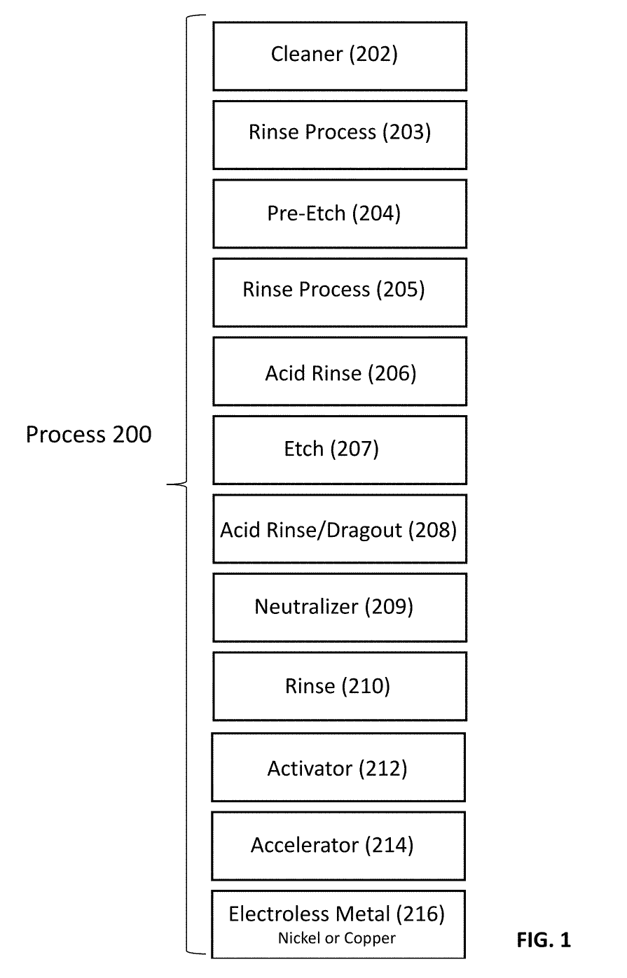

Most preferably, the vacuum evaporators disclosed herein are used in part of a larger method 200 for metallizing a nonconductive substrate. Referring to FIG. 1, a general description of the process for metallizing a nonconductive substrate 200 is shown. Optionally, the nonconductive substrate is cleaned by cleaner 202. The substrate is then rinsed in a series of one or more rinses 203. The nonconductive substrate is then optionally pre-etched by pre-etch 204. Pre-etching the nonconductive substrate swells the nonconductive substrate, making it more susceptible to etching. For any substrates immersed in the pre-etching solution a rinsing process of one or more rinses 205 is completed. Regardless of whether the optional cleaning and pre-etch steps occur, the nonconductive substrate is rinsed in an acid containing rinse 206 prior to being etched in etching bath 207. Etching bath 207 comprises a manganese containing etchant solution. Notably, in many embodiments the vacuum evaporator systems of the present invention operate to remove water from the etching bath 207 while maintaining the Specific Gravity. The etching bath 207 may further comprise an oxidation chamber for oxidizing a manganese ion at an oxidation state of less than +7 to Mn(VII). Optionally, the etched substrate may be conditioned with a conditioner to promote activation. Also optionally, the etched substrate may be rinsed to remove any excess acid or other undesirable materials on the etched substrate. Optionally, the etched substrate is pre-activated prior to activation. Pre-activation operates to facilitate absorption of the activator. After neutralization, the etched substrate is activated by exposing the etched substrate to activator 212. Activator 212 is typically a metal colloid or ionic solution selected from the metals of transition group VIII of the Periodic Table of the Elements and more preferably is selected from the group consisting of palladium, platinum, iridium, rhodium, and mixtures thereof along with a tin salt. Most preferably, activator 212 is palladium. Activator 212 fills the pores created by etching, after activation, the etched substrate undergoes accelerating 214. Accelerating 214 removes excess materials from the metal colloid, thereby ensuring metallization of the etched substrate as a result of the mechanical connection of the metal of the metal colloid with the pores of the etched substrate. After acceleration, the parts are immersed in the electroless nickel or electroless copper 216 to complete the metallization of the substrate.

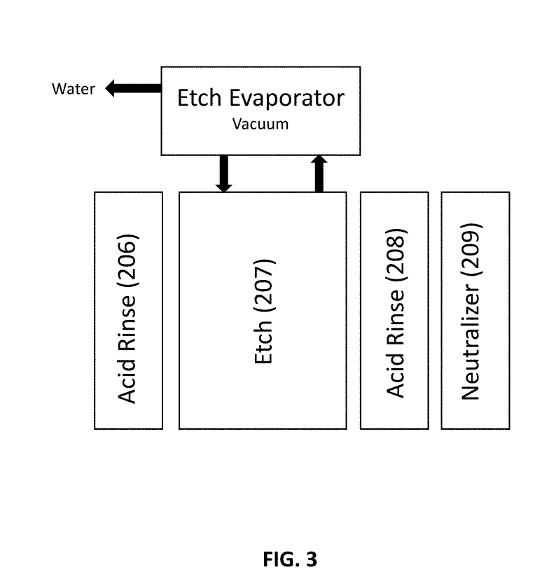

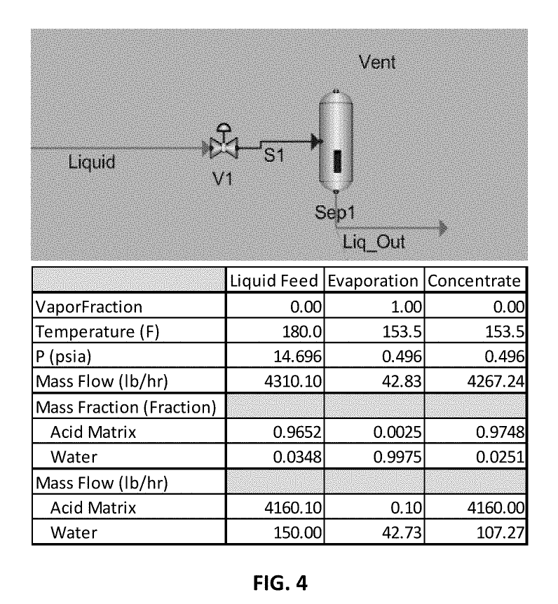

In view of the foregoing description of the method and possible alternative embodiments employed, an example of the water removal rates achievable in association with the method is presented in FIGS. 3 and 4.

Referring to FIG. 3, the parameters illustrated pertain to an embodiment where a first evaporator assembly is fluidly coupled to the etching bath 207. FIG. 4 demonstrates as a graphical depiction of the water removal rates obtained in the range around the parameters outlined in FIG. 3.

It was determined that for an etching bath having a composition of an acid matrix with specific gravity greater than or equal to 1.630 and Manganese Concentration of greater than or equal to 2 g/l, the acceptable rates of water removal by vacuum drop and water concentration are shown in various shades of green with the brightest green shades being optimal. The red shading depicts rates of water removal that were found to be sub-optimal and unacceptable.

In a non-limiting example of a solution compromising a mixed acid matrix and a manganese ion source being run at a rate to maintain production and development requirements, the evaporator fluidly coupled to the manganese ion source is utilized at pressures at or below 1.8 psig to achieve the desired concentration levels. The desired concentration levels are a function of the processing line speed and the solutions fluid properties within the treatment tank. For one particular example, if an etch bath operating at a specific gravity 1.650, it has been found that operating the evaporator at a pressure at or below 0.8 psig serves to sufficiently concentrate the evaporate so that it can be reintroduced into the treatment tank.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for removing water from a source of manganese ions, the method comprising:
directing at least a portion of the source of manganese ions through a conduit, wherein the conduit comprises a filter for filtering undissolved particles;
concentrating the portion of the source of manganese ions with a vacuum evaporator;
returning the concentrated portion to a manganese-based etchant bath.

2. The method according to claim 1, wherein the concentrated portion comprises an acid.

3. The method according to claim 2, further comprising purifying the acid.

4. The method according to claim 1, wherein the vacuum evaporator further comprises a heat source.

5. The method according to claim 1, wherein the manganese-based etchant bath is configured to etch a substrate.

6. The method according to claim 1, wherein a second conduit returns the concentrated portion to the manganese-based etchant bath.

7. The method according to claim 1, wherein the first conduit further comprises a one-way valve for preventing the portion of the source of manganese ions from returning to the source of manganese ions via the conduit.

8. A method for removing water from a manganese-based etchant bath, the method comprising:
directing at least a portion of a manganese-based etchant bath through a conduit, wherein the conduit comprises a one-way valve for prohibiting the portion of the manganese-based etchant bath from returning to the manganese-based etchant bath via the conduit;
concentrating the portion of the manganese-based etchant bath with a vacuum evaporator;
returning the concentrated portion to the manganese-based etchant bath.

9. The method according to claim 8, wherein the conduit further comprises further comprises a filter for filtering undissolved particles.

10. The method according to claim 8, wherein the concentrated portion comprises an acid.

11. The method according to claim 10, the acid is purified.

12. The method according to claim 8, wherein the vacuum evaporator further comprises a heat source.

13. The method according to claim 8, wherein the manganese-based etchant bath is configured to etch a substrate.

14. The method according to claim 8, wherein a second conduit returns the concentrated portion to the manganese-based etchant bath.

15. A system for removing water from a manganese-based etchant bath, the system comprising:
a manganese-based etchant bath;
a first conduit connected at a first end the manganese-based etchant bath; and at a second end a vacuum evaporator, wherein the first conduit comprises a filter for filtering undissolved particulates and allows at least a portion of the manganese-based etchant bath to flow through the first conduit into the vacuum evaporator;
a vacuum evaporator for evaporating water from and concentrating the portion of the manganese-based etchant bath that flows through the first conduit; and
a second conduit for directing the concentrated portion from the vacuum evaporator to the manganese-based etchant bath.

16. The system according to claim 15, wherein the vacuum evaporator further comprises a heating source for heating the contents of the vacuum evaporator.

17. The system according to claim 15, wherein the manganese-based etchant bath is configured to etch a substrate.

18. The system according to claim 15, concentrated portion comprises an acid.

19. The system according to claim 15, wherein the first conduit is configured for one-way passage from the manganese-based etchant bath to the vacuum evaporator.
